(19) United States
(12) Patent Application Publication
(10) Pub. No.: US 2026/0125850 A1
(43) Pub. Date: May 7, 2026

(54) Pretreatment Liquid For Textile Printing And Textile Printing Method

(71) Applicant: SEIKO EPSON CORPORATION, Tokyo (JP)

(72) Inventors: Toshiaki OGUCHI, Okaya (JP); Kazuki SHIMURA, Yamagata (JP); Yuta ASAKAWA, Azumino (JP)

(21) Appl. No.: 19/375,398

(22) Filed: Oct. 31, 2025

(30) Foreign Application Priority Data
Nov. 1, 2024 (JP) 2024-192735

(51) Int. Cl. D06P 5/00; C09D 11/102; C09D 11/328; C09D 11/54; D06P 1/16; D06P 1/52; D06P 1/54; D06P 5/28; D06P 5/30

(52) U.S. Cl. CPC D06P 5/002; C09D 11/102; C09D 11/328; C09D 11/54; D06P 1/16; D06P 1/5271; D06P 1/54; D06P 5/005; D06P 5/30

(57) ABSTRACT

A pretreatment liquid for textile printing according to the embodiment of the present disclosure includes a polyester resin (A) obtained by subjecting an alcohol component and a carboxylic acid component to polycondensation, a crosslinking agent, and water, in which the carboxylic acid component contains phthalic acid, an acid value of the polyester resin (A) is 5 to 40 mgKOH/g, an aromatic ring concentration of the polyester resin (A) is 4.20 to 5.20 mol/kg, and a glass transition temperature of the polyester resin (A) is 0° C. to 40° C.

The present application is based on, and claims priority from JP Application Serial Number 2024-192735, filed Nov. 1, 2024, the disclosure of which is hereby incorporated by reference herein in its entirety.

### BACKGROUND

### 1. Technical Field

The present disclosure relates to a pretreatment liquid for textile printing and a textile printing method.

### 2. Related Art

Conventionally, a technology in which, when a fabric is dyed with a coloring material to manufacture a printed matter, the fabric is subjected to a pretreatment by using a treatment liquid containing a resin to improve the color development property, wash fastness, and the like of the printed matter, is known, and various studies are made on the resin contained in the treatment liquid.

For example, JP-A-2011-099125 discloses a polyester resin aqueous dispersion in which a polyester resin is micro-dispersed in an aqueous medium. In addition, JP-A-2009-249773 discloses a pretreatment liquid consisting of an aqueous composition containing a resin, for applying to a polyester fabric.

However, it is difficult to obtain satisfactory levels in all of color fastness to change and fading, fabric hand, and wash fastness of the textile printed matter.

### SUMMARY

An aspect of a pretreatment liquid for textile printing according to the present disclosure includes a polyester resin (A) obtained by subjecting an alcohol component and a carboxylic acid component to polycondensation, a crosslinking agent, and water, in which the carboxylic acid component contains phthalic acid, an acid value of the polyester resin (A) is 5 to 40 mgKOH/g, an aromatic ring concentration of the polyester resin (A) is 4.20 to 5.20 mol/kg, and a glass transition temperature of the polyester resin (A) is 0° C. to 40° C.

An aspect of a textile printing method according to the present disclosure includes applying the pretreatment liquid for textile printing according to the above-described aspect onto a fabric, drying the fabric to which the pretreatment liquid for textile printing is applied by heating, recording by jetting an ink composition containing a disperse dye and water from an ink jet head to apply the ink composition to an intermediate transfer medium, and transferring the ink composition applied to the intermediate transfer medium onto the fabric to which the pretreatment liquid for textile printing is applied.

### BRIEF DESCRIPTION OF THE DRAWINGS

FIG. 1 is Table 1 showing compositions and evaluation results of pretreatment liquid for textile printing according to each example.

FIG. 2 is Table 2 showing compositions of polyester resins used in each example.

### DESCRIPTION OF EMBODIMENTS

Hereinafter, embodiments of the present disclosure will be described. The embodiments described below describe examples of the present disclosure. The present disclosure is not limited to the following embodiments, and includes various modifications implemented within a range not changing a gist of the present disclosure. It should be noted that not all of the configurations described below are essential configurations of the present disclosure.

In the present specification, a numerical range indicated by using “to” means a range including numerical values described before and after “to” as a lower limit value and an upper limit value.

### 1. PRETREATMENT LIQUID FOR TEXTILE PRINTING

A pretreatment liquid for textile printing according to the embodiment of the present disclosure includes a polyester resin (A) obtained by subjecting an alcohol component and a carboxylic acid component to polycondensation, a crosslinking agent, and water, in which the carboxylic acid component contains phthalic acid, an acid value of the polyester resin (A) is 5 to 40 mgKOH/g, an aromatic ring concentration of the polyester resin (A) is 4.20 to 5.20 mol/kg, and a glass transition temperature of the polyester resin (A) is 0° C. to 40° C.

When the aromatic ring concentration in the polyester resin is increased, an interaction with an aromatic ring structure that the disperse dye contained in the ink composition may have is enhanced, and the color fastness to change and fading and the wash fastness of the textile printed matter are improved. On the other hand, when the aromatic ring concentration is increased, the glass transition temperature of the polyester resin is increased because of the increased rigidity of the molecular chain, and the resin is solidified, which deteriorates the fabric hand. As described above, conventionally, it is difficult to achieve both the color fastness to change and fading and the wash fastness of the textile printed matter and the fabric hand of the textile printed matter.

As a result of intensive studies, it is found that, by using phthalic acid (orthophthalic acid) having low molecular symmetry as a carboxylic acid component in the polyester resin, even when the aromatic ring concentration is increased, the increase in rigidity of the molecular chain is reduced, that is, the increase in the glass transition temperature is suppressed. As a result, by adjusting the aromatic ring concentration and the glass transition temperature of the polyester resin contained in the pretreatment liquid for textile printing to a desired range, both the color fastness to change and fading and the wash fastness of the textile printed matter and the fabric hand of the textile printed matter can be achieved.

Hereinafter, each component contained in the pretreatment liquid for textile printing according to the present embodiment will be described.

### 1.1 Polyester Resin (A)

The pretreatment liquid for textile printing according to the present embodiment includes a polyester resin (A) obtained by subjecting an alcohol component and a carboxylic acid component to polycondensation.

A content (in terms of solid content) of the polyester resin (A) is not particularly limited, but is preferably 0.1% by mass or more, more preferably 0.5% by mass or more, still more preferably 1.0% by mass or more, particularly preferably 2.0% by mass or more, more particularly preferably 3.0% by mass or more, and particularly most preferably 4.0% by mass or more with respect to the total amount of the pretreatment liquid for textile printing.

In addition, an upper limit of the content (in terms of solid content) of the polyester resin (A) is not particularly limited, but is preferably 40% by mass or less, more preferably 30% by mass or less, still more preferably 20% by mass or less, even more preferably 15% by mass or less, particularly preferably 10% by mass or less, and more particularly preferably 7% by mass or less with respect to the total amount of the pretreatment liquid for textile printing.

When the content of the polyester resin (A) is 1% by mass or more, in particular, with respect to the total amount of the pretreatment liquid for textile printing in terms of solid content, the color development property and the wash fastness of the textile printed matter tend to be further improved. In addition, when the content of the polyester resin (A) is 20% by mass or less, in particular, with respect to the total amount of the pretreatment liquid for textile printing in terms of solid content, the fabric hand of the textile printed matter tends to be further improved.

### 1.1.1 Alcohol Component

Examples of the alcohol component include a diol (x1) and a polyol (x2) having a valence of 3 or more. These may be used alone or in combination of two or more types.

Examples of the diol (x1) include an alkylene glycol having 2 to 36 carbon atoms (ethylene glycol, propylene glycol, 1,3-propanediol, 1,4-butanediol, neopentyl glycol, 3-methyl-1,5-pentanediol, 1,6-hexanediol, 1,7-heptanediol, 1,8-octanediol, 1,9-nonanediol, 1,10-decanediol, 1,11-undecanediol, 1,12-dodecanediol, and the like), an alkylene ether glycol having 4 to 36 carbon atoms (diethylene glycol, triethylene glycol, dipropylene glycol, polyethylene glycol, polypropylene glycol, polytetramethylene ether glycol, and the like), an alicyclic diol having 6 to 36 carbon atoms (1,4-cyclohexanedimethanol, hydrogenated bisphenol A, and the like), a (poly)alkylene oxide adduct of the alicyclic diol (preferably having an average number of added moles of 1 to 30), an aromatic diol [a monocyclic divalent phenol (for example, hydroquinone and the like), bisphenols, and the like], and an alkylene oxide adduct of the aromatic diol (preferably having an average number of added moles of 2 to 30), and the like.

The alkylene oxide adduct of the bisphenols is obtained by adding an alkylene oxide (hereinafter, the “alkylene oxide” may be abbreviated as “AO”) to the bisphenols.

Examples of the bisphenols include those represented by General Formula (1), and the like.

HO—Ar—P—Ar—OH (1)

[In the formula, P represents an alkylene group having 1 to 3 carbon atoms, —SO₂—, —O—, —S—, or a direct bond, and Ar represents a phenylene group, in which a hydrogen atom may be substituted with a halogen atom or an alkyl group having 1 to 30 carbon atoms.]

Specific examples of the bisphenols include bisphenol A, bisphenol F, bisphenol B, bisphenol AD, bisphenol S, trichlorobisphenol A, tetrachlorobisphenol A, dibromobisphenol F, 2-methyl-bisphenol A, 2,6-dimethyl-bisphenol A, 2,2′-diethyl-bisphenol F, and the like, and two or more of these bisphenols can be used in combination.

Examples of the alkylene oxide to be added to the bisphenols include an alkylene oxide having 2 to 30 carbon atoms, for example, ethylene oxide (hereinafter, the “ethylene oxide” may be abbreviated as “EO”), propylene oxide (hereinafter, the “propylene oxide” may be abbreviated as “PO”), butylene oxide, tetrahydrofuran, a combination of two or more of these, and the like.

Among these diols (x1), from the viewpoint of solvent solubility of the polyester resin (A), an alkylene glycol having 2 to 36 carbon atoms or an alkylene oxide adduct of an aromatic diol is preferable, an alkylene glycol having 2 to 10 carbon atoms or an alkylene oxide adduct (preferably having an average number of added moles of 2 to 5) of bisphenols is more preferable, an alkylene glycol having 2 to 10 carbon atoms or an alkylene oxide adduct (preferably having an average number of added moles of 2 to 5) of bisphenol A is still more preferable, an alkylene glycol having 2 to 10 carbon atoms is particularly preferable, and an alkylene glycol having 2 to 6 carbon atoms is most preferable.

Examples of the polyol (x2) having a valence of 3 or more include an aliphatic polyhydric alcohol having 3 to 36 carbon atoms and a valence of 3 or more, sugars and derivatives thereof, an alkylene oxide adduct (preferably having an average number of added moles of 1 to 30) of an aliphatic polyhydric alcohol, an alkylene oxide adduct (preferably having an average number of added moles of 2 to 30) of trisphenols (such as trisphenol PA), and an alkylene oxide adduct (preferably having an average number of added moles of 2 to 30) of a novolac resin (including phenol novolac, cresol novolac, and the like, and preferably having an average degree of polymerization of 3 to 60), and the like.

Examples of the aliphatic polyhydric alcohol having 3 to 36 carbon atoms and a valence of 3 or more include an alkane polyol and intramolecular or intermolecular dehydration product thereof, and specific examples thereof include glycerol, trimethylolethane, trimethylolpropane, pentaerythritol, sorbitol, sorbitan, polyglycerol, dipentaerythritol, and the like.

In addition, examples of the sugars and the derivatives thereof include sucrose, methyl glucoside, and the like.

Among these polyols (x2) having a valence of 3 or more, from the viewpoint that the textile printed matter tends to exhibit excellent color fastness to change and fading, an aliphatic polyhydric alcohol having 3 to 36 carbon atoms and having a valence of 3 or more is preferable, an aliphatic polyhydric alcohol having 3 to 8 carbon atoms and having a valence of 3 is more preferable, and trimethylolpropane is particularly preferable.

From the viewpoint of solvent solubility during manufacturing of a resin aqueous dispersion for the polyester resin (A), the diol (x1) in the alcohol component of the polyester resin (A) is preferably 90 to 99.9 mol % and more preferably 95 to 99.8 mol %.

When the polyol (x2) having a valence of 3 or more is contained, from the viewpoint of solvent solubility and color fastness to change and fading during manufacturing of a resin aqueous dispersion for the polyester resin (A), the polyol (x2) having a valence of 3 or more in the alcohol component of the polyester resin (A) is preferably 0.1 to 10 mol % and more preferably 0.2 to 5 mol %.

In one aspect, the alcohol component can use a biomass-derived raw material. The biomass-derived raw material refers to a plant-derived raw material and a microorganism-derived raw material.

Examples of the alcohol component of the biomass-derived raw material include ethylene glycol, propylene glycol, 1,3-propanediol, 1,4-butanediol, neopentyl glycol, and the like.

In addition, a monohydric alcohol component may be contained in the alcohol component of the polyester resin (A) as necessary in addition to the polyol component. Examples of the monohydric alcohol include a linear or branched alkyl alcohol having 1 to 30 carbon atoms (methanol, ethanol, isopropanol, 1-decanol, dodecyl alcohol, myristyl alcohol, cetyl alcohol, stearyl alcohol, arachidyl alcohol, behenyl alcohol, and lignoceryl alcohol).

Among these monohydric alcohols, from the viewpoint that the textile printed matter tends to exhibit excellent color fastness to change and fading, a linear or branched alkyl alcohol having 8 to 24 carbon atoms is preferable, a linear alkyl alcohol having 8 to 24 carbon atoms is more preferable, and dodecyl alcohol, stearyl alcohol, arachidyl alcohol, behenyl alcohol, and lignoceryl alcohol are still more preferable.

### 1.1.2 Carboxylic Acid Component

The carboxylic acid component in the polyester resin (A) contains phthalic acid. It is considered that, because the carboxylic acid component contains phthalic acid and thus the orientation position is ortho-position, the molecular chain of the resulting polyester resin has a bent structure, and when the resulting polyester resin is used for an application as a treatment agent for dye-based textile printing, a disperse dye at the time of thermal transfer is easily taken into the molecular chain of the polyester resin, thereby readily imparting excellent color development property. In addition, it is considered that, because the skeleton has an asymmetric structure and thus rotation of the molecular chain is restricted, even when the glass transition temperature of the polyester resin is at or below around room temperature, the dye is fixed in the polyester resin during storage at room temperature, thereby readily imparting excellent color fastness to change and fading.

In addition, from the viewpoint of the color fastness to change and fading, the polyester resin (A) preferably includes, as the carboxylic acid component, a carboxylic acid component other than phthalic acid.

Examples of the carboxylic acid component other than phthalic acid include a dicarboxylic acid (y1) other than phthalic acid and a polycarboxylic acid (y2) having a valence of 3 or more. These may be used alone or in combination of two or more types.

It is noted that phthalic acid means orthophthalic acid, and may be phthalic acid anhydride, an alkyl (such as methyl, ethyl, butyl, and stearyl having 1 to 24 carbon atoms, preferably having 1 to 4 carbon atoms) ester, or a partially alkyl ester.

Examples of the dicarboxylic acid (y1) other than phthalic acid include an aromatic dicarboxylic acid having 8 to 36 carbon atoms (isophthalic acid, terephthalic acid, naphthalenedicarboxylic acid, and the like), an aliphatic dicarboxylic acid having 2 to 50 carbon atoms (oxalic acid, malonic acid, succinic acid, adipic acid, lepargylic acid, sebacic acid, and the like), an alicyclic dicarboxylic acid having 6 to 40 carbon atoms [dimer acid (dimerized linoleic acid) and the like], an alkenedicarboxylic acid having 4 to 36 carbon atoms (an alkenylsuccinic acid such as dodecenylsuccinic acid, maleic acid, fumaric acid, citraconic acid, mesaconic acid, and the like), ester-forming derivatives thereof, and the like. Here, the ester-forming derivative means a carboxylic acid anhydride, an alkyl (such as methyl, ethyl, butyl, and stearyl having 1 to 24 carbon atoms, preferably having 1 to 4 carbon atoms) ester, or a partially alkyl ester.

From the viewpoint that the textile printed matter tends to exhibit excellent color fastness to change and fading, among these dicarboxylic acids (y1), an aromatic dicarboxylic acid having 8 to 36 carbon atoms, an aliphatic dicarboxylic acid having 2 to 50 carbon atoms, or an alkenedicarboxylic acid having 4 to 36 carbon atoms is preferable, isophthalic acid, terephthalic acid, adipic acid, succinic acid, maleic acid, or fumaric acid is more preferable, isophthalic acid or terephthalic acid is still more preferable, and isophthalic acid is particularly preferable. In addition, these may be anhydrides or lower alkyl esters of these acids.

Examples of the polycarboxylic acid (y2) having a valence of 3 or more include an aromatic polycarboxylic acid having 9 to 20 carbon atoms (trimellitic acid, pyromellitic acid, and the like) and an aliphatic tricarboxylic acid (including an alicyclic tricarboxylic acid) having 6 to 36 carbon atoms (hexane tricarboxylic acid, decane tricarboxylic acid, and the like), ester-forming derivatives thereof, and the like.

Among these polycarboxylic acids (y2) having a valence of 3 or more, from the viewpoint of solubility, an aromatic polycarboxylic acid having 9 to 20 carbon atoms is preferable, and trimellitic acid or pyromellitic acid is more preferable. In addition, these may be anhydrides or lower alkyl esters of these acids.

From the viewpoint that the color development property of the textile printed matter tends to be more excellent, the content of the phthalic acid in the carboxylic acid component of the polyester resin (A) is preferably 1 mol % or more, more preferably 20 mol % or more, and particularly preferably 40 mol % or more.

When the dicarboxylic acid (y1) other than phthalic acid is contained, from the viewpoint that the color development property of the textile printed matter tends to be more excellent, the content of the dicarboxylic acid (y1) other than phthalic acid in the carboxylic acid component of the polyester resin (A) is preferably 99 mol % or less, more preferably 80 mol % or less, and particularly preferably 60 mol % or less.

When the carboxylic acid component contains isophthalic acid in addition to phthalic acid, from the viewpoint that the color development property and the color fastness to change and fading of the textile printed matter tend to be more excellent, a molar ratio (phthalic acid: isophthalic acid) of the phthalic acid to the isophthalic acid is preferably 1:99 to 99:1, more preferably 20:80 to 99:1, and particularly preferably 40:60 to 99:1.

In one aspect, the dicarboxylic acid (y1) other than phthalic acid can use a biomass-derived raw material. The biomass-derived raw material refers to a plant-derived raw material and a microorganism-derived raw material.

Examples of the dicarboxylic acid of the biomass-derived raw material include malonic acid, succinic acid, itaconic acid, adipic acid, azelaic acid, sebacic acid, dimer acid, and the like.

In addition, as necessary, a monocarboxylic acid component may be contained as the carboxylic acid component of the polyester resin (A). Examples of the monocarboxylic acid include an aromatic monocarboxylic acid having 7 to 37 carbon atoms (benzoic acid, toluic acid, 4-ethylbenzoic acid, 4-propylbenzoic acid, and the like), an aliphatic monocarboxylic acid (including alicyclic monocarboxylic acid) having 2 to 50 carbon atoms (acetic acid, propionic acid, butyric acid, valeric acid, caproic acid, enanthic acid, caprylic acid, pelargonic acid, capric acid, lauric acid, myristic acid, palmitic acid, margaric acid, stearic acid, behenic acid, and the like), and the like.

Among these monocarboxylic acids, from the viewpoint that the color fastness to change and fading of the textile printed matter tends to be more excellent, an aromatic monocarboxylic acid having 7 to 37 carbon atoms is preferable, and benzoic acid is more preferable.

### 1.1.3 Physical Properties

The aromatic ring concentration of the polyester resin (A) is 4.20 to 5.20 mol/kg, preferably 4.30 to 5.10 mol/kg, and more preferably 4.60 to 5.00 mol/kg. When the aromatic ring concentration of (A) is less than 4.20 mol/kg, the color fastness to change and fading is decreased, and when the aromatic ring concentration of (A) is more than 5.20 mol/kg, the storage stability is decreased.

The aromatic ring concentration of the polyester resin (A) is calculated by the following equation. [Aromatic ring concentration (mol/kg)]=[Aromatic ring amount (mol) when all raw materials of the polyester resin (A) are completely reacted]/[Total mass (kg) of raw materials constituting the polyester resin (A)−Ester bond amount (mol) when all raw materials of the polyester resin (A) are completely reacted×18×10⁻³] The aromatic ring concentration of the polyester resin (A) can be adjusted by adjusting the aromatic ring concentration and the content of the alcohol component and the carboxylic acid component.

The ester group concentration of the polyester resin (A) is preferably 8.2 to 10.4 mol/kg, more preferably 8.8 to 10.2 mol/kg, and still more preferably 9.2 to 10.0 mol/kg. When the ester group concentration of (A) is 8.2 mol/kg or more, the color fastness to change and fading tends to be good, and when the ester group concentration is 10.4 mol/kg or less, the solvent solubility of the polyester resin (A) tends to be good.

It is noted that the ester group concentration of the polyester resin (A) is calculated by the following equation. [Ester group concentration (mol/kg)]=[Ester bond amount (mol) when all raw materials of the polyester resin (A) are completely reacted]/[Total mass (kg) of raw materials constituting the polyester resin (A)−Ester bond amount (mol) when all raw materials of the polyester resin (A) are completely reacted×18×10⁻³] The ester group concentration of the polyester resin (A) can be adjusted by adjusting the molar concentration of the hydroxyl group and the ester group concentration of the alcohol component and the molar concentration of the carboxy group and the ester group concentration of the carboxylic acid component.

The acid value of the polyester resin (A) is 5 to 40 mgKOH/g, preferably 6 to 30 mgKOH/g, and more preferably 7 to 25 mgKOH/g. When the acid value of the polyester resin (A) is less than 5 mgKOH/g, the particle diameter of the polyester resin (A) increases and the storage stability deteriorates, and when the acid value of the polyester resin (A) is more than 40 mgKOH/g, the amount of the component dissolved in water as the medium increases and the storage stability deteriorates. In the present application, the acid value of the polyester resin (A) refers to the acid value of a free acid (carboxy group) before being neutralized when the polyester resin (A) is neutralized with an alkali.

From the viewpoint of storage stability, the hydroxyl value of the polyester resin (A) is preferably 0 to 40 mgKOH/g, more preferably 0.1 to 30 mgKOH/g, and still more preferably 0.1 to 25 mgKOH/g. When the acid value is more than 40 mgKOH/g, the amount of the component dissolved in water as the medium increases and the storage stability deteriorates.

The acid value and the hydroxyl value can be measured by the method defined in JIS K0070.

A glass transition temperature (Tg) of the polyester resin (A) is 0° C. to 40° C., preferably 5° C. to 35° C., and more preferably 10° C. to 30° C. When the Tg of the polyester resin (A) is lower than 0° C., the color fastness to change and fading deteriorates, and when the Tg of the polyester resin (A) is higher than 40° C., the fabric hand deteriorates.

The glass transition temperature (Tg) of the polyester resin (A) can be appropriately adjusted by the type of each raw material component and the amount used thereof, and the manufacturing conditions such as the reaction temperature, the reaction time, and the cooling rate.

The glass transition temperature (Tg) of the polyester resin (A) can be measured by the method (DSC method) defined in ASTM D3418-82. As the measurement of the glass transition temperature (Tg), for example, DSC Q20 manufactured by TA Instruments, or the like can be used. The glass transition temperature (Tg) can be measured under the following conditions.

### Measurement Conditions

(1) Temperature rising from 30° C. to 150° C. at 20° C./min
(2) Maintaining at 150° C. for 10 minutes
(3) Cooing to −35° C. at 20° C./min
(4) Maintaining at −35° C. for 10 minutes
(5) Temperature rising to 150° C. at 20° C./min
(6) Analyzing the differential scanning calorimetry curve measured in the process of (5), and regarding the position of the inflection point as the glass transition temperature.

From the viewpoint of storage stability and color fastness to change and fading, a peak top average molecular weight of the polyester resin (A) is preferably 3,000 to 20,000, more preferably 7,500 to 20,000, and still more preferably 10,000 to 20,000.

In the present disclosure, the peak top average molecular weight can be measured under the following conditions using gel permeation chromatography (GPC).
Apparatus (example): HLC-8120 manufactured by Tosoh Corporation
Column (example): two columns of TSK GEL GMH6 [manufactured by Tosoh Corporation]
Measurement temperature: 40° C.
Sample solution: 0.25% by weight THF solution
Solution filling amount: 100 μl
Detection apparatus: refractive index detector
Standard substance: standard polystyrene manufactured by Tosoh Corporation (TSK standard POLYSTYRENE), 12 points (molecular weight of 500, 1,050, 2,800, 5,970, 9,100, 18,100, 37,900, 96,400, 190,000, 355,000, 1,090,000, and 2,890,000)

For the measurement of the molecular weight, a sample solution is obtained by dissolving the sample in tetrahydrofuran (THF) to a concentration of 0.25% by weight and filtering out the insoluble matter with a PTFE filter of an aperture of 220 nm.

In one aspect, from the viewpoint of solving petroleum resource depletion and environmental considerations, the biomass concentration in the polyester resin (A) is preferably 1% by weight or more, more preferably 10% by weight or more, and still more preferably 20% by weight or more. The biomass concentration means a weight proportion (% by weight) of a constitutional monomer derived from biomass with respect to a total amount of the alcohol component and the carboxylic acid component from which PET flakes are removed from the polyester resin (A).

### 1.1.4 Manufacturing Method

Manufacturing method of the polyester resin (A) will be described.

The polyester resin (A) can be obtained by mixing an alcohol component and a carboxylic acid component containing phthalic acid and subjecting the mixture a polycondensation reaction in the presence of a polymerization catalyst.

In addition, the ethylene glycol component and the terephthalic acid component contained in the polyester resin (A) may be an ethylene glycol component or a terephthalic acid component derived from polyethylene terephthalate (PET). In this time, the polyester resin (A) can be obtained by mixing PET with other alcohol components and other carboxylic acid components and subjecting the mixture to a polycondensation reaction in the presence of a polymerization catalyst.

Specifically, the polyester resin (A) can be manufactured, for example, as follows. For example, the alcohol component and the carboxylic acid component are subjected to a polycondensation reaction in an inert gas (nitrogen gas or the like) atmosphere at a reaction temperature of preferably 150° C. to 280° C., more preferably 160° C. to 250° C., and still more preferably 170° C. to 235° C. from the viewpoint of the polycondensation reactivity and the coloring of the resin.

In addition, as described above, PET may be mixed together with the alcohol component and the carboxylic acid component.

In this time, an esterification catalyst can be used as necessary.

Examples of the esterification catalyst include a tin-containing catalyst (for example, dibutyltin oxide and the like), antimony trioxide, a titanium-containing catalyst [for example, titanium alkoxide (titanium tetrabutoxide and the like), potassium titanium oxalate, titanium terephthalate, titanium terephthalate alkoxide, a catalyst described in JP-A-2006-243715 {for example, titanium diisopropoxybis(triethanolaminate), titanium dihydroxybis(triethanolaminate), titanium monohydroxytris(triethanolaminate), titanium bis(triethanolaminate), an intramolecular polycondensate thereof, and the like}, and a catalyst described in JP-A-2007-11307 (titantributoxyterephthalate, titantriisopropoxyterephthalate, and titanium diisopropoxyditerephthalate)], a zirconium-containing catalyst (for example, zirconium acetate and the like), zinc acetate, and the like. Among these, a titanium-containing catalyst is preferable.

In addition, a stabilizer may be added to stably promote the polymerization of the polyester. Examples of the stabilizer include hydroquinone, methylhydroquinone, a hindered phenol compound, and the like.

### 1.1.5 Resin Aqueous Dispersion

The polyester resin (A) may be used as a resin aqueous dispersion in which the resin is dispersed in an aqueous medium. The aqueous medium is a medium containing at least water, and may contain an organic solvent or the like. Such an organic solvent can be the same as the organic solvent (described later) of the organic solvent solution of the polyester resin (A) obtained by the above-described manufacturing method.

A manufacturing method of the resin aqueous dispersion of the polyester resin (A) is not particularly limited as long as it includes a step of mixing the organic solvent solution of the polyester resin (A) with an aqueous medium.

Examples of the manufacturing method of the resin aqueous dispersion containing the polyester resin (A) include the following method [1].

[1] A method of dissolving a polyester resin (A) in an organic solvent to manufacture a polyester resin solution, then, as necessary, neutralizing a carboxyl group of the polyester resin with a neutralizer such as potassium hydroxide to form a salt, dispersing the salt in an aqueous medium, and then, as necessary, distilling off the organic solvent.

In the step of dispersing the polyester resin (A) in the aqueous medium in [1], it is preferable to use a rotary dispersion mixing apparatus described later, and from the viewpoint of storage stability, the temperature is preferably 60° C. or lower and more preferably 40° C. or lower. In addition, the dispersion time can be appropriately selected depending on the apparatus used, but is generally preferably 1 minute to 2 hours and more preferably 3 minutes to 1 hour.

Examples of the organic solvent of the organic solvent solution of the polyester resin (A) in the manufacturing method of the resin aqueous dispersion include an aromatic hydrocarbon solvent, an aliphatic or alicyclic hydrocarbon solvent, a halogenated solvent, an ester, an ester-ether solvent, an ether solvent, a ketone solvent, an alcohol solvent, an amide solvent, a sulfoxide solvent, a heterocyclic compound solvent, a mixed solvent of two or more of these, and the like.

Specific examples of the organic solvent include aromatic hydrocarbon solvents (toluene, xylene, ethylbenzene, tetralin, and the like); aliphatic or alicyclic hydrocarbon solvents (n-hexane, n-heptane, mineral spirit, cyclohexane, and the like); halogenated solvents such as methyl chloride, methyl bromide, methyl iodide, methylene dichloride, carbon tetrachloride, trichloroethylene, and perchloroethylene; ester or ester-ether solvents such as ethyl acetate, butyl acetate, methoxybutyl acetate, methyl cellosolve acetate, and ethyl cellosolve acetate; ether solvents such as diethyl ether, tetrahydrofuran, dioxane, ethyl cellosolve, butyl cellosolve, and propylene glycol monomethyl ether; ketone solvents such as acetone, methyl ethyl ketone, methyl isobutyl ketone, di-n-butyl ketone, and cyclohexanone; alcohol solvents such as methanol, ethanol, n-propanol, isopropanol, n-butanol, isobutanol, tert-butanol, 2-ethylhexyl alcohol, and benzyl alcohol; amide solvents such as dimethylformamide and dimethylacetamide; sulfoxide solvents such as dimethyl sulfoxide); heterocyclic compound solvents such as N-methylpyrrolidone; mixed solvents of two or more of these; and the like. Among the above-described organic solvents, volatile organic solvents having a boiling point of less than 100° C. are preferable. Preferred examples of the organic solvent include ethyl acetate, acetone, isopropanol, tetrahydrofuran, methyl ethyl ketone, and the like.

The amount of the organic solvent used with respect to 100 parts by weight of the polyester resin (A) is preferably 25 to 300 parts by weight, more preferably 25 to 150 parts by weight, and still more preferably 25 to 100 parts by weight from the viewpoint of solvent solubility of the resin.

In the manufacturing method of the resin aqueous dispersion, as the aqueous medium in the step of mixing the organic solvent solution of the polyester resin (A) with the aqueous medium, any liquid containing water as an essential component can be used without limitation, such as water, an aqueous solution of an organic solvent, an aqueous solution of a surfactant(s) described later, an aqueous solution of a water-soluble polymer (t), and a mixture of two or more of these.

To improve the dispersibility of the polyester resin (A) in the aqueous medium, a neutralizer may be used to neutralize the carboxyl group of the polyester resin (A). Examples of the neutralizer include organic compounds such as ammonia and triethylamine, and inorganic compounds such as potassium hydroxide and sodium hydroxide.

From the viewpoint of dispersibility, the amount of the neutralizer used is preferably 1 to 150 mol % and more preferably 5 to 100 mol % with respect to the carboxyl group of the polyester resin (A).

When dispersing the polyester resin (A) in an aqueous medium, a known surfactant (s) and an inorganic dispersant can be used as an emulsifier or a dispersant as necessary.

The surfactant (s) is not particularly limited, and examples thereof include an anionic surfactant (s-1), a cationic surfactant (s-2), an amphoteric surfactant (s-3), a nonionic surfactant (s-4), and the like. The surfactants(s) may be a combination of two or more surfactants.

Examples of the anionic surfactant (s-1) include a carboxylic acid or a salt thereof, a sulfate ester salt, a carboxymethylate salt, a sulfonate salt, a phosphate ester salt, and the like.

Examples of the cationic surfactant (s-2) include a quaternary ammonium salt type surfactant, an amine salt type surfactant, and the like.

Examples of the amphoteric surfactant (s-3) include a carboxylate-type amphoteric surfactant, a sulfate ester salt-type amphoteric surfactant, a sulfonate-type amphoteric surfactant, a phosphate ester salt-type amphoteric surfactant, and the like.

Examples of the nonionic surfactant (s-4) include an AO addition type nonionic surfactant, a polyhydric alcohol type nonionic surfactant, and the like.

Specific examples of these surfactants(s) include those described in JP2002-284881A, and the like.

Examples of the inorganic dispersant include polyvalent metal phosphates such as tricalcium phosphate, magnesium phosphate, aluminum phosphate, zinc phosphate, and hydroxyapatite; carbonates such as calcium carbonate and magnesium carbonate; inorganic salts such as calcium metasilicate, calcium sulfate, and barium sulfate; and inorganic compounds such as magnesium hydroxide and aluminum hydroxide.

When dispersing the polyester resin (A) in an aqueous medium, a known water-soluble polymer (t) can be used as an emulsifier or a dispersant.

Examples of the water-soluble polymer (t) include a cellulose compound (for example, methyl cellulose, ethyl cellulose, hydroxyethyl cellulose, ethyl hydroxyethyl cellulose, carboxymethyl cellulose, hydroxypropyl cellulose, a saponification product thereof, and the like), gelatin, starch, dextrin, gum arabic, chitin, chitosan, polyethylene glycol, and the like.

A method of dispersion when mixing the organic solvent solution of the polyester resin (A) with the aqueous medium is not particularly limited, but a rotary dispersion mixing apparatus, an ultrasonic disperser, or a kneader is preferably used, and among these, a rotary dispersion mixing apparatus having particularly excellent dispersing ability is more preferable.

Examples of the rotary dispersion mixing apparatus include a mixing apparatus having general stirring blades such as MaxBlend and a helical blade, a TK homomixer [produced by Primix Corporation], Clearmix [produced by M Technique Co., Ltd.], Filmix [produced by Primix Corporation], Ultra-Turrax [produced by IKA Co., Ltd.], Ebara Milder [produced by Ebara Corporation], Cavitron (produced by Eurotec Co., Ltd.), Biomixer [produced by Nippon Seiki Co., Ltd.], and the like.

The amount of the aqueous medium used with respect to 100 parts by weight of the organic solvent solution of the polyester resin (A) is preferably 100 to 500 parts by weight, more preferably 150 to 400 parts by weight, and still more preferably 150 to 300 parts by weight from the viewpoint of storage stability.

A particle diameter of the particles of the polyester resin (A) in the resin aqueous dispersion is preferably 30 to 250 nm, more preferably 30 to 200 nm, and particularly preferably 30 to 190 nm, from the viewpoint of storage stability. In the present disclosure, the particle diameter means a cumulant average particle diameter. The particle diameter can be measured and determined by the light scattering measurement method described below.

### Method of Measuring Particle Diameter of Particles of Polyester Resin (A) in Resin Aqueous Dispersion

The cumulant analysis is performed using a zeta potential/particle diameter/molecular weight measurement system [manufactured by Otsuka Electronics Co., Ltd., “ELS-Z-2000”], and the cumulant average particle diameter obtained by the measurement is regarded as the average particle diameter of the polyester resin (A) in the resin aqueous dispersion. A dispersion liquid of particles to be measured is put into a measuring cell, and the measurement conditions are a temperature of 25° C., a measurement angle of 165°, and an integrated number of 25 times, and a refractive index of water (1.333) is input as a refractive index of a dispersion solvent. The dispersion liquid is obtained by diluting the resin aqueous dispersion of the polyester resin (A) with ion exchange water to 100 times.

### 1.2 Crosslinking Agent

The pretreatment liquid for textile printing according to the present embodiment contains a crosslinking agent. In the pretreatment liquid for textile printing, crosslinkability can be imparted by containing the crosslinking agent, and the polyester resin (A), the dye contained in the ink composition, and the fabric can be bonded to each other.

The crosslinking agent can be appropriately selected from known crosslinking agents and used, and the crosslinking agent may initiate a crosslinking reaction at normal temperature or may initiate a crosslinking reaction by heat. Examples of such a crosslinking agent include a crosslinking agent having self-crosslinking properties, a compound having in the molecule a plurality of functional groups that react with an unsaturated carboxylic acid component, and a metal having a polyvalent coordination position.

Since the color fastness to change and fading and the wash fastness of the textile printed matter can be more preferably achieved in combination with the fabric hand of the textile printed matter, it is preferable that the crosslinking agent include an isocyanate group and/or an oxazoline group.

Examples of the isocyanate group-containing crosslinking agent include a water dispersion type (blocked) polyisocyanate and the like. The (blocked) polyisocyanate means a polyisocyanate and/or a blocked polyisocyanate.

Examples of the water dispersion type polyisocyanate include products obtained by dispersing a polyisocyanate that is imparted with hydrophilicity by a polyethylene oxide chain, in water with an anionic dispersant or a nonionic dispersant.

Examples of the polyisocyanate include diisocyanates such as hexamethylene diisocyanate and isophorone diisocyanate; and derivatives (modification products) of polyisocyanate such as a trimethylolpropane adduct form, a biuret form, and an isocyanurate form of these diisocyanates. These polyisocyanates may be used singly or in combination of two or more types thereof.

The water dispersion type blocked polyisocyanate is obtained by blocking the isocyanate groups of the water dispersion type polyisocyanate with a blocking agent. Examples of the blocking agent include diethyl malonate, ethyl acetoacetate, ε-caprolactam, butanone oxime, cyclohexanone oxime, 1,2,4-triazole, dimethyl-1,2,4-triazole, 3,5-dimethylpyrazole, and imidazole. These blocking agents may be used singly, or two or more types thereof may be used in combination.

Regarding such an isocyanate group-containing crosslinking agent, a commercially available product can also be used. Examples of the commercially available product include FIXER #100ECO, #104EA, #220, 70ECO, #70, #410, and #400 (all trade names, Murayama Chemical Laboratory Co., Ltd.); and ELASTRON (registered trademark) BN-11, BN-27, BN-69, and BN-77 (all trade names, Daiichi Kogyo Seiyaku Co., Ltd.).

Examples of the oxazoline group-containing crosslinking agent include a compound having two or more oxazoline groups in the molecule. Examples of such an oxazoline group-containing compound include 2,2′-bis(2-oxazoline), 2,2′-methylene-bis(2-oxazoline), 2,2′-ethylene-bis(2-oxazoline), 2,2′-trimethylene-bis(2-oxazoline), 2,2′-tetramethylene-bis(2-oxazoline), 2,2′-hexamethylene-bis(2-oxazoline), 2,2′-octamethylene-bis(2-oxazoline), 2,2′-ethylene-bis(4,4′-dimethyl-2-oxazoline), 2,2′-p-phenylene-bis(2-oxazoline), 2,2′-m-phenylene-bis(2-oxazoline), 2,2′-m-phenylene-bis(4,4′-dimethyl-2-oxazoline), bis(2-oxazolinylcyclohexane) sulfide, bis(2-oxazolinylnorbornane) sulfide and an oxazoline ring-containing polymer. These oxazoline group-containing compounds may be used singly or in combination of two or more kinds thereof.

Since the polyester resin (A), the dye, and the fabric can bond more strongly, thereby obtaining a textile printed matter having more excellent washing fastness, the oxazoline group-containing compound is preferably a water-soluble oxazoline group-containing compound.

Regarding such an oxazoline group-containing crosslinking agent, a commercially available product can also be used. Examples of the commercially available product include EPOCROS (registered trademark) K-2010, K-2020, K-2030, K-2035E, WS-300, WS-500, and WS-700 (all trade names, Nippon Shokubai Co., Ltd.).

Regarding the crosslinking agent, one type thereof may be used alone, or two or more types thereof may be used in combination.

A content (in terms of solid content) of the crosslinking agent is not particularly limited, but is preferably 0.01% by mass or more, more preferably 0.1% by mass or more, still more preferably 0.5% by mass or more, particularly preferably 1.0% by mass or more, more particularly preferably 1.5% by mass or more, and particularly most preferably 2.0% by mass or more with respect to the total amount of the pretreatment liquid for textile printing.

In addition, an upper limit of the content (in terms of solid content) of the crosslinking agent is not particularly limited, but is preferably 10% by mass or less, more preferably 8% by mass or less, still more preferably 5% by mass or less, even more preferably 3% by mass or less, and particularly preferably 2.5% by mass or less with respect to the total amount of the pretreatment liquid for textile printing.

A mass ratio (polyester resin/crosslinking agent) of the polyester resin (A) to the crosslinking agent is preferably 0.1 to 20, more preferably 0.5 to 10, still more preferably 1 to 5, particularly preferably 1.2 to 3, and more particularly preferably 1.5 to 2.5. It is noted that when the polyester resin (A) or the crosslinking agent is in an aspect such as an emulsion, the mass ratio is calculated in terms of solid content.

### 1.3 Water

The pretreatment liquid for textile printing according to the present embodiment contains a water.

Water is evaporated and scattered by drying, after applying the pretreatment liquid for textile printing to the fabric. Examples of water include pure water such as ion-exchanged water, ultrafiltration water, reverse osmosis water, and distilled water; and ultrapure water, from which ionic impurities are removed as much as possible. Furthermore, water sterilized by irradiation with ultraviolet radiation, addition of hydrogen peroxide, or the like is preferred because growth of fungi and bacteria can be suppressed when the pretreatment liquid for textile printing is stored for a long period of time.

A content of the water is preferably 30% by mass or more, more preferably 50% by mass or more, still more preferably 70% by mass or more, particularly preferably 80% by mass or more, and still more particularly preferably 90% by mass or more with respect to the total amount of the pretreatment liquid for textile printing. An upper limit of the content of the water is not particularly limited, but is, for example, preferably 99% by mass or less, more preferably 98% by mass or less, and still more preferably 97% by mass or less with respect to the total amount of the pretreatment liquid for textile printing.

By setting the water content within the above range, the increase in viscosity of the pretreatment liquid for textile printing can be suppressed, and there is a tendency that the workability when applying the pretreatment liquid for textile printing to the fabric, as well as the drying property after application, can be improved.

### 1.4 Organic Solvent

The pretreatment liquid for textile printing according to the present embodiment may contain an organic solvent. The organic solvent is preferably a water-soluble organic solvent. It is noted that the “water solubility” means that the solubility in water at 20° C. is more than 10 g/100 g of water.

Examples of the organic solvent include esters, alkylene glycol ethers, cyclic esters, amides, alcohols, polyhydric alcohols, and the like.

Examples of esters include glycol monoacetates such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, methoxybutyl acetate; glycol diesters such as ethylene glycol diacetate, diethylene glycol diacetate, propylene glycol diacetate, dipropylene glycol diacetate, ethylene glycol acetate propionate, ethylene glycol acetate butyrate, diethylene glycol acetate butyrate, diethylene glycol acetate propionate, diethylene glycol acetate butyrate, propylene glycol acetate propionate, propylene glycol acetate butyrate, dipropylene glycol acetate butyrate, dipropylene glycol acetate propionate, and the like.

Examples of the alkylene glycol ethers include alkylene glycol monoalkyl ethers and alkylene glycol dialkyl ethers. Specific examples include alkylene glycol monoalkyl ethers such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, and tripropylene glycol monobutyl ether; alkylene glycol dialkyl ethers such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether; and the like.

Examples of cyclic esters include cyclic esters (lactones) such as β-propiolactone, γ-butyrolactone, δ-valerolactone, ε-caprolactone, β-butyrolactone, β-valerolactone, γ-valerolactone, β-hexanolactone, γ-hexanolactone, δ-hexanolactone, β-heptanolactone, γ-heptanolactone, δ-heptanolactone, ε-heptanolactone, γ-octanolactone, δ-octanolactone, ε-octanolactone, δ-nonalactone, ε-nonalactone, and ε-decanolactone; compounds in which a hydrogen of a methylene group adjacent to a carbonyl group thereof is substituted with an alkyl group having 1 to 4 carbon atoms, and the like.

Examples of the amides include cyclic amides, acyclic amides, and the like. Examples of the acyclic amides include alkoxyalkylamides and the like.

Examples of the cyclic amides include lactams. Examples of the lactams include pyrrolidones such as 2-pyrrolidone, 1-methyl-2-pyrrolidone, 1-ethyl-2-pyrrolidone, 1-propyl-2-pyrrolidone, and 1-butyl-2-pyrrolidone.

Examples of alkoxyalkylamides include 3-methoxy-N,N-dimethylpropionamide, 3-methoxy-N,N-diethylpropionamide, 3-methoxy-N,N-methylethylpropionamide, 3-ethoxy-N,N-dimethylpropionamide, 3-ethoxy-N,N-diethylpropionamide, 3-ethoxy-N,N-methylethylpropionamide, 3-n-butoxy-N,N-dimethylpropionamide, 3-n-butoxy-N,N-diethylpropionamide, 3-n-butoxy-N,N-methylethylpropionamide, 3-n-propoxy-N,N-dimethylpropionamide, 3-n-propoxy-N,N-diethylpropionamide, 3-n-propoxy-N,N-methylethylpropionamide, 3-iso-propoxy-N,N-dimethylpropionamide, 3-iso-propoxy-N,N-diethylpropionamide, 3-iso-propoxy-N,N-methylethylpropionamide, 3-tert-butoxy-N,N-dimethylpropionamide, 3-tert-butoxy-N,N-diethylpropionamide, 3-tert-butoxy-N,N-methylethylpropionamide, N,N-dimethylisobutyrate amide, and the like.

Examples of alcohols include a compound in which one hydrogen atom of alkane is substituted with a hydroxyl group. The alkane preferably has 10 or less carbon atoms, more preferably 6 or less carbon atoms, and further more preferably 3 or less carbon atoms. The number of carbon atoms of the alkane is 1 or more, and is preferably 2 or more. The alkane may be a linear type or a branched type. Examples of alcohols include methanol, ethanol, n-propyl alcohol, iso-propyl alcohol, n-butanol, 2-butanol, tert-butanol, iso-butanol, n-pentanol, 2-pentanol, 3-pentanol, tert-pentanol, 2-phenoxy ethanol, benzyl alcohol, phenoxy propanol, and the like.

Polyhydric alcohols have two or more hydroxyl groups in the molecule. The polyhydric alcohols can be divided into, for example, alkanediols and polyols.

Examples of alkanediols include compounds in which alkane is substituted with two hydroxyl groups. Examples of alkanediols include 1,2-alkanediol, which is a general term for compounds in which hydroxyl groups are substituted at the first and second positions of alkanes, and other alkanediols other than 1,2-alkanediol.

Examples of the 1,2-alkanediol include ethylene glycol, 1,2-propanediol (propylene glycol), 1,2-butanediol (1,2BD), 1,2-pentanediol (1,2PD), 1,2-hexanediol (1,2HD), 1,2-heptanediol, 1,2-octanediol, 1,2-nonanediol, 1,2-decanediol, 3-methyl-1,2-butanediol, 3-methyl-1,2-pentanediol, 4-methyl-1,2-pentanediol, 3,4-dimethyl-1,2-pentanediol, 3-ethyl-1,2-pentanediol, 4-ethyl-1,2-pentanediol, 3-methyl-1,2-hexanediol, 4-methyl-1,2-hexanediol, 5-methyl-1,2-hexanediol, 3,4-dimethyl-1,2-hexanediol, 3,5-dimethyl-1,2-hexanediol, 4,5-dimethyl-1,2-hexanediol, 3-ethyl-1,2-hexanediol, 4-ethyl-1,2-hexanediol, and 3-ethyl-4-methyl-1,2-hexanediol.

Examples of other alkanediols include 1,3-propanediol, 1,3-butylene glycol (also known as 1,3-butanediol), 1,4-butanediol, 2,3-butanediol, 1,5-pentanediol, 2,4-pentanediol, 2-methyl-1,3-propanediol, 3-methyl-1,3-butanediol, 3-methyl-1,5-pentanediol, 2-ethyl-1,3-hexanediol, 2-methyl-1,3-pentanediol, 3-methyl-1,5-pentanediol, 2-methylpentane-2,4-diol, 1,6-hexanediol, 2-ethyl-2-methyl-1,3-propanediol, 2-methyl-2-propyl-1,3-propanediol, and the like.

Examples of the polyols include a condensate in which two or more molecules of alkanediols are intermolecularly condensed between hydroxyl groups, a compound having three or more hydroxyl groups, and the like.

Examples of the condensate in which two or more molecules of alkanediols are intermolecularly condensed between hydroxyl groups include dialkylene glycol such as diethylene glycol and dipropylene glycol, trialkylene glycol such as triethylene glycol and tripropylene glycol, and the like.

The compound having three or more hydroxyl groups is a compound having three or more hydroxyl groups having an alkane or polyether structure as a skeleton. Examples of the compound having three or more hydroxyl groups include glycerol, trimethylolethane, trimethylolpropane, 1,2,5-hexanetriol, 1,2,6-hexanetriol, pentaerythritol, polyoxypropylenetriol, and the like.

The organic solvent may be used alone or in combination of two or more thereof.

The pretreatment liquid for textile printing according to the present embodiment preferably contains one or more selected from a glycol-based solvent or a glycerol derivative as the organic solvent. When such an organic solvent is contained, the color development property of the textile printed matter tends to be further improved.

The glycol-based solvent refers to a solvent consisting of an aliphatic or alicyclic compound in which two hydroxyl groups are bonded to two different carbon atoms. Examples of the glycol-based solvent include alkanediols, a condensate in which two or more molecules of alkanediols are intermolecularly condensed between hydroxyl groups, and the like, and alkanediols are preferable and 1,2-alkanediol is more preferable.

Examples of the glycerol derivative include polyoxyalkylene glyceryl ether which is glycerol to which at least one type of alkylene oxide is added or addition-polymerized. Examples of the alkylene oxide include ethylene oxide, propylene oxide, and an alkylene oxide having 4 carbon atoms (1,2-butylene oxide, 2,3-butylene oxide, tetramethylene oxide, and the like), and the like.

Examples of the polyoxyalkylene glyceryl ether include polyoxyethylene glyceryl ether, polyoxypropylene glyceryl ether, polyoxyethylene polyoxypropylene glyceryl ether, and the like.

As the polyoxyalkylene glyceryl ether, a commercially available product may be used, and examples thereof include SANNIX GP-250, GP-400, GP-600, GP-700, GP-1000, GP-1500, and GP-3000 (all of which are trade names manufactured by Sanyo Chemical Industries, Ltd.).

The content of the organic solvent is preferably 1% to 20% by mass, more preferably 2% to 18% by mass, still more preferably 3% to 15% by mass, and particularly preferably 5% to 10% by mass with respect to the total amount of the pretreatment liquid for textile printing. In addition, it is also preferable that one or more organic solvents selected from a glycol-based solvent or a glycerol derivative are within the above range.

### 1.5 Viscosity Modifier

The pretreatment liquid for textile printing according to the present embodiment may contain a viscosity modifier. When the viscosity modifier is contained, the color development property tends to be further improved.

Examples of the viscosity modifier include an inorganic thickener and an organic thickener.

Examples of the inorganic thickener include inorganic compounds such as silica (SiO₂), alumina, or titania, and clay minerals such as bentonite or montmorillonite, and among these, a silica powder, a hydrophobically-treated silica powder, or a mixture thereof is preferable.

Specific examples thereof include silica fine powder pulverized by a dry method [for example, manufactured by Nippon Aerosil Co., Ltd., trade name: AEROSIL 300 and the like], a fine powder obtained by modifying the silica fine powder with trimethyl disilazane [for example, manufactured by Nippon Aerosil Co., Ltd., trade name: AEROSIL RX300 and the like], and a fine powder obtained by modifying the silica fine powder with polydimethylsiloxane [for example, manufactured by Nippon Aerosil Co., Ltd., trade name: AEROSIL RY300 and the like], and the like. From the viewpoint of imparting thickening properties and pseudo-plasticity, an average particle diameter of the inorganic thickener is preferably 5 to 50 μm and more preferably 5 to 12 μm.

Examples of the organic thickener include polysaccharides, water-soluble thickening resins, and modified products thereof.

Examples of the polysaccharides include xanthan gum (Kelzan), welan gum, rhamsan gum, succinoglycan, guar gum, locust bean gum, pullulan, dextran, dextrin, tragacanth gum, tara gum, ghatti gum, arabinogalactan gum, gum arabic, quillaja seed gum and derivatives thereof, and pectin, starch, carrageenan, agar, alginic acid, gelatin, casein, glucomannan, carrageenin, benzylidene sorbitol and benzylidene xylitol, Rheozan, diutan gum, and the like.

Examples of the water-soluble thickening resin include cellulose-based compounds such as carboxyethyl cellulose, ethyl cellulose, hydroxyethyl cellulose, carboxymethyl cellulose, and viscose, vinyl-based compounds consisting of water-soluble polymers such as polyvinyl alcohol and polyvinylpyrrolidone, alkyd resins, acrylic resins, styrene-maleic acid copolymers, cellulose derivatives, polyvinylpyrrolidone, polyvinyl alcohol, poly(meth)acrylic acid-based compounds, polyether-modified urethane compounds, polyurethane-based compounds such as hydrophobically-modified polyoxyethylene polyurethane copolymers, polyamide-based compounds such as polyamide wax amine salts, urea-based compounds such as urethane-urea-based compounds, and the like. Examples thereof include ester-based compounds such as alkyl esters of alginic acid and an alkyl ester of methacrylic acid, polyvinyl alcohol, polyvinylpyrrolidone, polyethylene oxide, polyethylene glycol, a vinylpyrrolidone/vinyl acetate copolymer, a vinylpyrrolidone/dimethylaminoethyl methacrylate copolymer, polyacrylamide, poly N-vinylacetamide, N-vinylacetamide resins and derivatives thereof, and a urethane-urea-based thickener, an amide-urea-based thickener, and the like.

From the viewpoint that the color development property tends to be more excellent, the viscosity modifier is preferably a urethane-based thickener. It is noted that the urethane-based thickener may be a commercially available product, and examples thereof include SN Thickener 621TF, 660T, and 665T (all of which are trade names manufactured by San-Nopco Ltd.).

The content of the viscosity modifier is preferably 0.01% to 5% by mass, more preferably 0.05% to 3% by mass, still more preferably 0.1% to 1% by mass, and particularly preferably 0.1% to 0.5% by mass with respect to the total amount of the pretreatment liquid for textile printing.

### 1.6 Other Components

The pretreatment liquid for textile printing according to the present embodiment may contain various additives such as a surfactant, a dissolution aid, a pH adjuster, an antioxidant, an antiseptic agent, an antifungal agent, a corrosion inhibitor, and a chelating agent. Regarding the additives, one type thereof may be used alone, or two or more types thereof may be used in combination.

The content of each additive may be, for example, 0.01% to 5.0% by mass with respect to the total amount of the pretreatment liquid for textile printing.

### 1.7 Manufacturing Method of Pretreatment Liquid for textile Printing

The pretreatment liquid for textile printing can be prepared by mixing each of the components in any order and performing filtration or the like as necessary to remove impurities, foreign substances, and the like. As a mixing method for each of the components, a method of sequentially introducing each component into a container equipped with a stirring device such as a mechanical stirrer or a magnetic stirrer, and carrying out stirring and mixing, is used. Examples of the filtration method include centrifugal filtration and filter filtration.

### 1.8 Physical Properties

The viscosity at 20° C. of the pretreatment liquid for textile printing is preferably 1.5 mPa·s or more and 100 mPa·s or less. By setting the viscosity of the pretreatment liquid for textile printing in the above-described range, the coatability such as the ease of spreading of the pretreatment liquid for textile printing when the treatment liquid is attached to the fabric, can be improved.

The viscosity of the pretreatment liquid for textile printing can be measured by using, for example, a viscoelasticity tester MCR-300 (Physica Messtechnik GmbH). Specifically, the viscosity can be measured by adjusting the temperature of the pretreatment liquid for textile printing to 20° C. and reading the shear viscosity (mPa·s) at a shear rate of 200 (1/s).

The surface tension at 25° C. of the pretreatment liquid for textile printing is preferably 30 mN/m or more and 50 mN/m or less. By setting the surface tension at 25° C. of the pretreatment liquid for textile printing in the above-described range, appropriate wettability and permeability to the fabric are exhibited. Furthermore, since the pretreatment liquid for textile printing is easily absorbed uniformly by the fabric, a density difference in the applied amount occurring when applying the pretreatment liquid for textile printing, that is, the occurrence of coating unevenness, can be suppressed.

It is noted that the surface tension of the pretreatment liquid for textile printing can be measured by using, for example, an automatic surface tension meter CBVP-Z (Kyowa Interface Science Co., Ltd.). Specifically, measurement can be made by reading the surface tension when a platinum plate is wetted with the pretreatment liquid for textile printing in an environment at 25° C.

### 2. TEXTILE PRINTING METHOD

A textile printing method according to the embodiment of the present disclosure includes applying the pretreatment liquid for textile printing according to the above-described aspect onto a fabric, drying the fabric to which the pretreatment liquid for textile printing is applied by heating, recording by applying an ink composition containing a disperse dye and water to an intermediate transfer medium, and transferring the ink composition applied to the intermediate transfer medium onto the fabric to which the pretreatment liquid for textile printing is applied.

The textile printing method according to the present embodiment uses the above-described pretreatment liquid for textile printing, and both the color fastness to change and fading and the wash fastness of the textile printed matter and the fabric hand of the textile printed matter is achieved.

Hereinafter, each step included in the textile printing method according to the present embodiment will be described.

### 2.1 Coating Step

The textile printing method according to the present embodiment includes a coating step of applying the above-described pretreatment liquid for textile printing to a fabric.

Examples of a method of applying the pretreatment liquid for textile printing to a fabric include an immersion coating method of immersing a fabric in the pretreatment liquid for textile printing; a roller coating method of applying the pretreatment liquid for textile printing with a mangle roller, a roll coater, or the like; a spray coating method of ejecting the pretreatment liquid for textile printing by using a spray apparatus or the like; and an ink jet coating method of ejecting the pretreatment liquid for textile printing by an ink jet method. Regarding those coating methods, one method may be used alone to attach the pretreatment liquid for textile printing to the fabric, or two or more methods may be combined to attach the pretreatment liquid for textile printing to the fabric.

In the present embodiment, from the viewpoint that the degree of freedom in designing the applied amount of the pretreatment liquid for textile printing is increased, problems at the time of application are less likely to occur, and the pretreatment liquid for textile printing can be uniformly applied to the fabric, it is preferable to apply the pretreatment liquid for textile printing to the fabric by a roller coating method using rollers such as a mangle roller and a roll coater.

An applied amount of the pretreatment liquid for textile printing to the fabric is not particularly limited, but is preferably 0.1 to 10 g/cm², more preferably 0.5 to 8 g/cm², still more preferably 1 to 5 g/cm², and particularly preferably 2 to 3 g/cm². By setting the applied amount of the pretreatment liquid for textile printing within the above-described range, the pretreatment liquid for textile printing can be applied more uniformly to the fabric, and the color development property tends to be further improved.

A form of the fabric is not particularly limited, and examples thereof include a cloth, clothing, and other accessories. The cloth includes a woven fabric, a knitted fabric, a nonwoven fabric, and the like. The clothing and other clothing ornaments include sewn T-shirts, handkerchiefs, scarves, towels, handbags, and fabric furniture such as bags, curtains, sheets, bedspreads, and wallpaper, cloth before and after cutting as parts to be sewn, and the like. Examples of these forms include a long roll-shaped product, a product cut into a predetermined size, and a product having the shape of a manufactured product.

The material constituting the fabric is not particularly limited, examples thereof include natural fibers such as cotton, linen, wool, and silk, synthetic fibers such as polypropylene, polyester, acetate, triacetate, polyamide, and polyurethane, and biodegradable fibers such as polylactic acid, and blended fibers thereof may be used.

Regarding the fabric, a fabric that is colored in advance with a dye may be used. Examples of the dye with which the fabric is colored in advance include water-soluble dyes such as an acidic dye and a basic dye; disperse dyes used in combination with dispersants; reactive dyes; and solvent dyes.

### 2.2 Drying Step

The textile printing method according to the present embodiment includes a drying step of drying the fabric to which the pretreatment liquid for textile printing is applied by heating.

Examples of the heating method include a heat pressing method, a normal pressure steaming method, a high pressure steaming method, and a thermofixing method. In addition, examples of a heat source of the heating include an infrared radiation (lamp).

In addition, the heating temperature is, for example, preferably 210° C. or lower, more preferably 200° C. or lower, and still more preferably 190° C. or lower. As a result, even when the fabric is colored in advance with a dye, there is a tendency that sublimation of the dye during heat drying can be suppressed, and fading of the ground color of the fabric can be prevented. In addition, the lower limit of the heating temperature may be such that the medium such as moisture contained in the pretreatment liquid for textile printing volatilizes, and is preferably 100° C. or higher, more preferably 120° C. or higher, and still more preferably 140° C. or higher.

Here, the heating temperature refers to an average temperature in a region of the fabric surface to be recorded. In addition, the drying time is preferably 10 seconds or more and 10 minutes or less, more preferably 20 seconds or more and 5.0 minutes or less, and still more preferably 20 seconds or more and 3.0 minutes or less.

Furthermore, the pressure when pressurizing and heating is preferably 0.05 to 5 N/cm², more preferably 0.1 to 1 N/cm², and still more preferably 0.15 to 0.5 N/cm².

### 2.3 Recording Step

The textile printing method according to the present embodiment includes a recording step of recording by jetting an ink composition containing a disperse dye and water from an ink jet head to apply the ink composition to an intermediate transfer medium.

The applied amount of the ink composition on the intermediate transfer medium is not particularly limited, but for example, it is preferably 3 to 20 mg/inch², more preferably 5 to 17 mg/inch², and still more preferably 8 to 15 mg/inch².

As the intermediate transfer medium, for example, paper such as plain paper, and a recording medium provided with an ink-receiving layer can be used. The recording medium provided with the ink-receiving layer is referred to as, for example, ink jet paper or coated paper. Among those, paper provided with an ink-receiving layer containing inorganic particles such as silica is more preferable. As a result, in a process of drying the ink composition applied to the intermediate transfer medium, an intermediate recorded material in which bleeding on the recording surface and the like are suppressed can be obtained. Furthermore, when such a medium is used, a disperse dye can be more easily retained at the surface of the recording surface, and there is a tendency that sublimation of the disperse dye can be performed more efficiently in the subsequent transfer step.

### 2.3.1 Ink Composition

The ink composition used in the recording step includes a disperse dye and water. Hereinafter, each component included in the ink composition will be described. The ink composition is preferably an ink jet ink composition that is jetted from an ink jet head to apply to a recording medium for use by an ink jet method.

### 2.3.1.1 Disperse Dye

The ink composition contains a disperse dye as a dye. The disperse dye is a coloring material that usually forms a particle form and is dispersed in a dispersion medium by a dispersant. Furthermore, the disperse dye is usually a nonionic dye having a hydrophilic group and an appropriate polar group. Regarding the disperse dye, one type thereof may be used alone, or two or more types thereof may be used in combination.

Examples of the disperse dye include C.I. Disperse Yellow, C.I. Disperse Red, C.I. Disperse Blue, C.I. Disperse Orange, C.I. Disperse Violet, C.I. Disperse Green, C.I. Disperse Brown, and C.I. Disperse Black.

Among those, a sublimation dye is preferred as a dispersant. Here, the “sublimation dye” refers to a dye having a property of sublimating by heating.

Specific examples of such a sublimation dye include C.I. Disperse Yellow 3, 7, 8, 23, 39, 51, 54, 60, 71, and 86; C.I. Disperse Orange 1, 1:1, 5, 20, 25, 25:1, 33, 56, and 76; C.I. Disperse Brown 2; C.I. Disperse Red 11, 50, 53, 55, 55:1, 59, 60, 65, 70, 75, 93, 146, 158, 190, 190:1, 207, 239, and 240; C.I. Vat Red 41; C.I. Disperse Violet 8, 17, 23, 27, 28, 29, 36, and 57; C.I. Disperse Blue 14, 19, 26, 26:1, 35, 55, 56, 58, 64, 64:1, 72, 72:1, 81, 81:1, 91, 95, 108, 131, 141, 145, and 359; and C.I. Solvent Blue 36, 63, 105, and 111.

In the present embodiment, from the viewpoint that more satisfactory dyeability tends to be obtained for a fabric having the pretreatment liquid for textile printing applied thereto and a printed matter having sufficient color development property tends to be obtained, a cyan dye, a red dye, and a yellow dye are preferable. Since the printed matter having more satisfactory dyeability and sufficient color development property is obtained, the cyan dye is more preferably C.I. Disperse Blue 359, the red dye is more preferably C.I. Disperse Red 60, and the yellow dye is more preferably C.I. Disperse Yellow 54.

A content of the disperse dye is preferably 0.5% to 15% by mass, more preferably 1% to 10% by mass, still more preferably 2% to 8% by mass, and particularly preferably 3% to 6% by mass with respect to the total amount of the ink composition.

### 2.3.1.2 Water

The ink composition includes water. The water is the same as that described above for the pretreatment liquid for textile printing.

A content of the water is preferably 30% to 90% by mass, more preferably 40% to 80% by mass, and still more preferably 50% to 75% by mass with respect to the total amount of the ink composition.

### 2.3.1.3 Dispersant

The ink composition may include a dispersant. When the ink composition includes a dispersant, excellent dispersibility of the disperse dye tends to be obtained, and excellent clogging resistance of the ink composition is obtained.

Examples of the dispersant include sodium naphthalene sulfonate-formalin condensate and a resin. Sodium naphthalene sulfonate-formalin condensate is a compound obtained by subjecting a sulfonate having a naphthalene ring in the molecule to formalin-condensation, or a salt thereof. Regarding the dispersant, one type thereof may be used alone, or two or more types thereof may be used in combination.

From the viewpoint of having more satisfactory dispersibility, it is preferable that a resin is included as the dispersant. Examples of the resin include a urethane-based resin, a styrene-acrylic resin, an acrylic resin, a fluorene-based resin, a polyolefin-based resin, a rosin-modified resin, a terpene-based resin, a polyester-based resin, a polyamide-based resin, an epoxy-based resin, a vinyl chloride-based resin, a vinyl chloride-vinyl acetate copolymer, and an ethylene-vinyl acetate-based resin. Among those, from the viewpoint of having excellent clogging resistance, the resin is preferably a urethane-based resin or a styrene-acrylic resin, and more preferably a styrene-acrylic resin.

The urethane-based resin is not particularly limited as long as it is a resin having a urethane bond in the molecule. Examples of the urethane-based resin include a polyether-type urethane resin including an ether bond in the main chain in addition to a urethane bond, a polyester-type urethane resin including an ester bond in the main chain in addition to a urethane bond, and a polycarbonate-type urethane resin including a carbonate bond in the main chain in addition to a urethane bond. Regarding the urethane-based resin, one type thereof may be used alone, or two or more types thereof may be used in combination.

As the urethane-based resin, a commercially available product can also be used. Examples of the commercially available product include TAKELAC (registered trademark) W6110 (trade name) manufactured by Mitsui Chemicals, Inc.; ACRIT (registered trademark) WBR-022U (trade name) manufactured by Taisei Fine Chemical Co., Ltd.; PERMARIN (registered trademark) UX-368T (trade name), UPRENE (registered trademark) UXA-307 (trade name), and U-COAT (registered trademark) UWS-145 (trade name) manufactured by Sanyo Chemical Industries, Ltd.; and SOLSPERSE (registered trademark) 47000 (trade name) manufactured by Lubrizol Corporation.

Examples of the styrene-acrylic resin include a styrene-acrylic acid copolymer, a styrene-methacrylic acid copolymer, a styrene-methacrylic acid-acrylic acid ester copolymer, a styrene-α-methylstyrene-acrylic acid copolymer, and a styrene-α-methylstyrene-acrylic acid-acrylic acid ester copolymer. Those copolymers may in the form of any of a random copolymer, a block copolymer, an alternating copolymer, and a graft copolymer.

As the styrene-acrylic resin, a commercially available product can also be used. Examples of the commercially available product include JONCRYL (registered trademark) 67 (trade name) manufactured by BASF Japan, Ltd. ; and SOLSPERSE (registered trademark) 43000 (trade name) manufactured by Lubrizol Corporation.

A content of the dispersant is preferably 0.5% to 15% by mass, more preferably 1% to 10% by mass, still more preferably 2% to 8% by mass, and particularly preferably 3% to 6% by mass with respect to the total amount of the ink composition.

In addition, a ratio of the content of the disperse dye to the content of the dispersant is preferably 0.5 to 1.5, more preferably 0.7 to 1.2, and still more preferably 0.9 to 1.1.

### 2.3.1.4 Surfactant

The ink composition may include a surfactant.

Examples of the surfactant include an acetylene glycol-based surfactant, a fluorine-based surfactant, and a silicone-based surfactant. The surfactant may be used alone or may be used in combination of two or more types thereof.

Examples of the acetylene glycol-based surfactant include 2,4,7,9-tetramethyl-5-decyne-4,7-diol and an alkylene oxide adduct thereof, and 2,4-dimethyl-5-decyn-4-ol and an alkylene oxide adduct thereof. As the acetylene glycol-based surfactant, a commercially available product can also be used. Examples of the commercially available product include OLFINE (registered trademark) 104 series (trade name) and E series (trade name) manufactured by Nissin Chemical Industry Co., Ltd.; and SURFYNOL (registered trademark) series (trade name) manufactured by Air Products and Chemicals, Inc.

Examples of the fluorine-based surfactant include a perfluoroalkyl sulfonic acid salt, a perfluoroalkyl carboxylic acid salt, a perfluoroalkyl phosphoric acid ester, a perfluoroalkyl ethylene oxide adduct, a perfluoroalkyl betaine, and a perfluoroalkylamine oxide compound.

As the fluorine-based surfactant, a commercially available product can also be used. Examples of the commercially available product include S-144 (trade name) and S-145 (trade name) manufactured by Asahi Glass Co., Ltd.

Examples of the silicone-based surfactant include a polysiloxane-based compound and a polyether-modified organosiloxane.

As the silicone-based surfactant, a commercially available product can also be used. Examples of the commercially available product include 306, 307, 333, 341, 345, 346, 347, 348, and 349 (all trade names) of BYK (registered trademark) series manufactured by BYK Chemie Japan K.K.

The content of the surfactant is preferably 0.01% to 10% by mass, more preferably 0.05% to 5% by mass, still more preferably 0.1% to 3% by mass, and particularly preferably 0.3% to 1% by mass with respect to the total amount of the ink composition.

### 2.3.1.5 Organic Solvent

The ink composition may contain an organic solvent. The organic solvent is the same as that described above for the pretreatment liquid for textile printing.

A content of the organic solvent is preferably 5% to 40% by mass, more preferably 8% to 35% by mass, still more preferably 10% to 30% by mass, and particularly preferably 15% to 25% by mass with respect to the total amount of the ink composition.

### 2.3.1.6 Other Components

The ink composition may include various additives such as a dissolution aid, a viscosity modifier, a pH adjuster, an antioxidant, an antiseptic agent, an antifungal agent, a corrosion inhibitor, and a chelating agent for capturing metal ions that affect dispersion.

Regarding the additives, one type thereof may be used alone, or two or more types thereof may be used in combination.

Examples of the antiseptic agent include sodium pentachlorophenol, sodium 2-pyridinethiol-1-oxide, and 1,2-dibenzinethiazolin-3-one.

As the antiseptic agent, a commercially available product can also be used. Examples of the commercially available product include CRL, BND, GXL, XL-2, and TN (all trade names) of PROXEL (registered trademark) series manufactured by Lonza Japan, Ltd. Regarding the antiseptic agent, one type thereof may be used alone, or two or more types thereof may be used in combination.

The content of each additive may be, for example, 0.01% to 5.0% by mass with respect to the total amount of the ink composition.

### 2.3.1.7 Manufacturing Method of Ink Composition

The ink composition can be prepared by the same method as the above-described pretreatment liquid for textile printing. In addition, to more satisfactorily disperse the disperse dye in the ink composition, a dye dispersion liquid may be prepared in advance, and the ink composition may be prepared by using the dye dispersion liquid instead of the disperse dye. The dye dispersion liquid can be obtained by, for example, mixing a disperse dye, water, and a dispersant in any order and dispersing the mixture by using a paint shaker or the like.

### 2.3.1.8 Physical Properties

The surface tension of the ink composition at 25° C. is 40 mN/m or less, preferably 38 mN/m or less, more preferably 35 mN/m or less, and even more preferably 30 mN/m or less from the viewpoint of ensuring appropriate wet spreadability to the fabric.

The viscosity of the ink composition at 20° C. is preferably 1.5 mPa·s or more and 15 mPa·s or less, more preferably 1.5 mPa·s or more and 7 mPa·s or less, and even more preferably 1.5 mPa·s or more and 5.5 mPa·s or less.

### 2.4 Transfer Step

The textile printing method according to the present embodiment includes a transfer step of transferring the above-described ink composition applied to an intermediate transfer medium to a fabric to which a pretreatment liquid for textile printing is applied.

The transfer step is a step of heating the surface of the intermediate transfer medium, to which the ink composition is attached, and the fabric surface to which the pretreatment liquid for textile printing is applied, in a state in which the surfaces face each other, and transferring the disperse dye included in the ink composition to the fabric having the pretreatment liquid for textile printing applied thereto. As a result, the disperse dye is transferred, and a printed matter, which is a fabric to which the ink composition is applied, is obtained.

In the present step, the intermediate transfer medium to which the ink composition is applied may be heated in a state in which the intermediate transfer medium is arranged to face the fabric having the pretreatment liquid for textile printing applied thereto. In the present step, it is more preferable to heat the intermediate transfer medium and the fabric having the pretreatment liquid for textile printing applied thereto in a state of being brought into close contact with each other. As a result, for example, a clearer image can be recorded on the fabric having the pretreatment liquid for textile printing applied thereto, that is, dyeing can be achieved.

Examples of the heating method include steaming with steam, heat pressing with dry heat, a thermosol, an HT steamer with superheated steam, and an HP steamer with pressurized steam. The fabric to which the ink composition is applied may be immediately subjected to a heating treatment or may be subjected to a heating treatment after a lapse of a predetermined time. Since a printed matter having sufficient color development property, color fastness to change and fading, and washing fastness can be obtained, a dry heat is preferable as the heating method.

The heating temperature is preferably 160° C. to 220° C., more preferably 170° C. to 210° C., and particularly preferably 180° C. to 190° C. When the heating temperature is within the above-described range, the energy required for transfer can be further reduced, and the productivity of the printed matter tends to be more excellent. In addition, the color development property of the printed matter tends to be more excellent.

The heating time depends on the heating temperature, but is preferably 30 to 120 seconds and more preferably 40 to 90 seconds. When the heating time is within the above-described range, the energy required for transfer can be further reduced, and the productivity of the printed matter tends to be superior. In addition, the color development property of the printed matter tends to be more excellent.

Furthermore, the pressure when pressurizing and heating is preferably 10 to 50 g/cm², more preferably 15 to 40 g/cm², and still more preferably 20 to 30 g/cm².

The applied amount of the ink composition to the fabric by the transfer is, for example, preferably 1.5 to 6.0 mg/cm² per unit area of the fabric. By setting the applied amount of the ink composition within the above-described range, the color development property of the image formed by the textile printing is improved, and the drying property of the ink applied to the fabric is secured, and the occurrence of bleeding of the image tends to be reduced.

### 2.5 Other Steps

The textile printing method according to the present embodiment may include, as necessary, a step of preliminarily heating the fabric on which the pretreatment liquid for textile printing is applied, a step of washing the fabric on which the pretreatment liquid for textile printing is applied, a step of washing the printed matter, and the like.

### 2.6 Ink Jet Recording Apparatus

The ink jet recording apparatus that can be used in the textile printing method according to the present embodiment is not particularly limited as long as it has at least an ink container that accommodates the ink composition and an ink jet head coupled to the ink container, and can form an image on a recording medium such as an intermediate transfer medium by jetting the ink composition from the ink jet head. As the ink jet recording apparatus, either a serial type or a line type can be used. The ink jet recording apparatuses of these types are equipped with an ink jet head, and the droplets of the ink composition is intermittently jetted from a nozzle hole of the ink jet head at a predetermined timing and in a predetermined volume with a relative positional relationship between the recording medium and the ink jet head being changed. As a result, the ink composition can be attached to the recording medium, and a predetermined transfer image can be formed.

Generally, in a serial type ink jet recording apparatus, the direction of transport of the recording medium and the direction of reciprocating motion of the ink jet head intersect each other, and the relative positional relationship between the recording medium and the ink jet head is changed by a combination of the reciprocating motion of the ink jet head and the transporting motion of the recording medium. In addition, in this case, generally, a plurality of nozzle holes are disposed in the ink jet head, and a row of nozzle holes, that is, a nozzle array is formed along the direction of transport of the recording medium. Furthermore, in the ink jet head, a plurality of nozzle arrays may be formed according to the type and number of ink compositions.

Furthermore, generally, in a line type ink jet recording apparatus, the ink jet head does not perform reciprocating motion, and the relative positional relationship between the recording medium and the ink jet head is changed by transporting the recording medium, whereby the relative positional relationship between the recording medium and the ink jet head is changed. Even in this case, generally, a plurality of nozzle holes are disposed in the ink jet head, and a nozzle array is formed along a direction intersecting the direction of transport of the recording medium.

### 3. EXAMPLE

Hereinafter, the present disclosure will be described in more detail with reference to examples, but the present disclosure is not limited to these examples. Hereinafter, “%” is based on mass unless otherwise specified.

### 3.1 Preparation of Pretreatment Liquid for Textile Printing

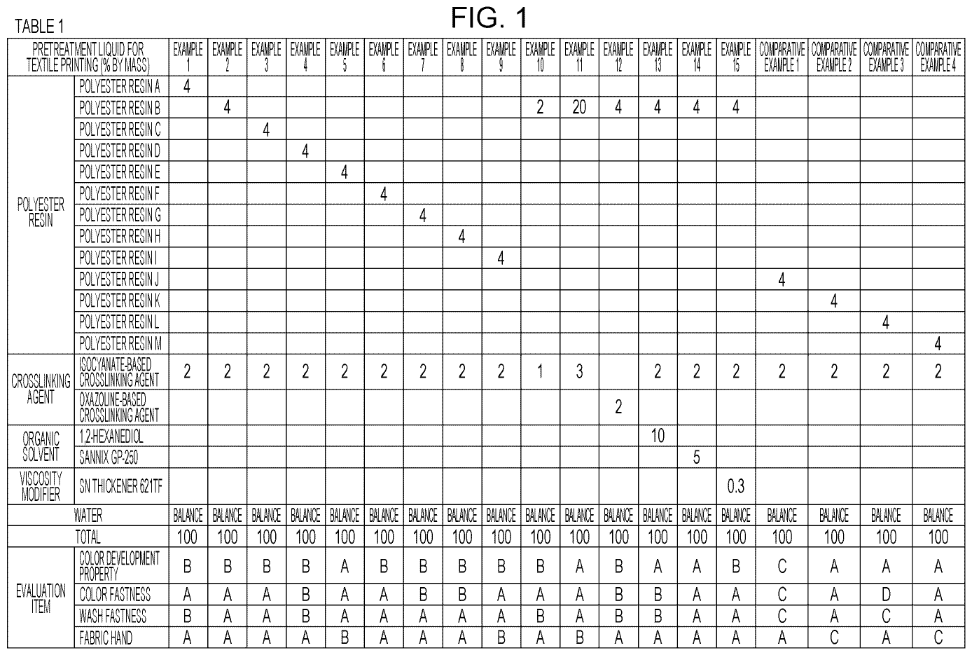

A pretreatment liquid for textile printing according to each example was obtained by putting respective components into a tank for a mixture so as to have compositions shown in Tables 1 (FIG. 1), mixing and stirring the components, and further filtering the components with a membrane filter of 5 μm.

It is noted that the numerical value of the blending amount of each component in Table 1 represents % by mass. The components of the polyester resin and the crosslinking agent are shown in terms of solid content. Water was added such that the total mass of the composition was 100% by mass.

Explanations regarding Table 1 will be supplemented.

### Polyester Resin

Polyester resins A to M were obtained by the following procedure.

### Manufacturing Method of Polyester Resin A

422 parts by weight of diethylene glycol, 27 parts by weight of trimethylolpropane, 348 parts by weight of terephthalic acid, 348 parts by weight of isophthalic acid, and 6 parts by weight of phthalic acid anhydride were charged into a reaction tank with a cooling pipe, a thermometer, a stirrer, and a nitrogen introduction pipe, 1,000 ppm of titanium tetrabutoxide as a condensation catalyst with respect to the total weight of the raw materials was charged, and the mixture was reacted at 200° C. for 6 hours in a nitrogen stream with the generated water being distilled off. The reaction was further performed under reduced pressure of 0.5 to 2.5 kPa, the reaction product was taken out from the reaction tank, and a polyester resin A was obtained.

### Manufacturing Method of Polyester Resins B to M

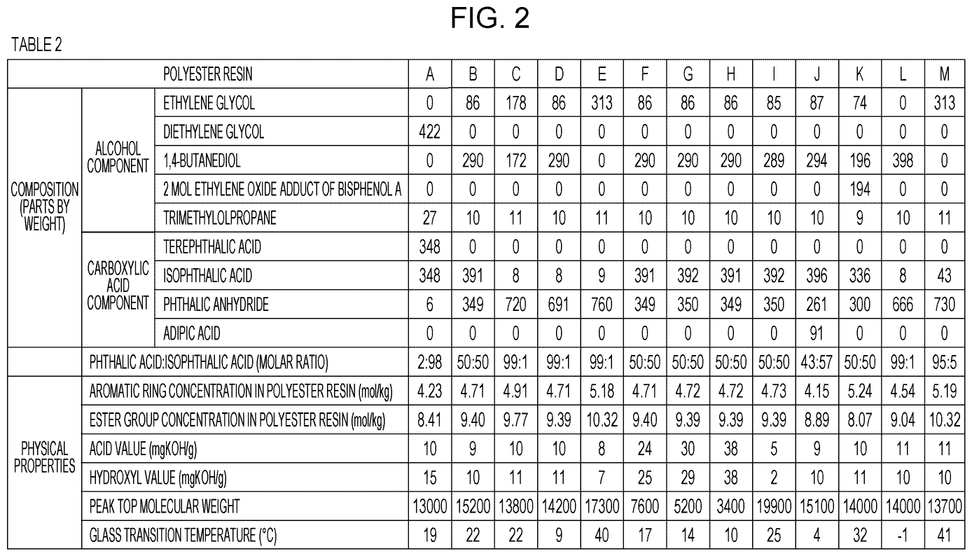

The alcohol component, the carboxylic acid component, and the like shown in Table 2 (FIG. 2) were charged into a reaction tank with a cooling pipe, a stirrer, and a nitrogen introduction pipe, and the reaction was performed in the same manner as in the manufacturing method of polyester resin A, except for this, to obtain polyester resins B to M. The physical properties of each polyester resin are shown in Table 2. However, the excess amount of ethylene glycol was distilled off outside the reaction system. The composition ratio of the polyester resin shown in Table 2 is a composition ratio of the final composition, and the composition of the polyester resin was measured by quantifying a molar ratio of the polyhydric alcohol component and the polycarboxylic acid component constituting the polyester resin using a 1H-nuclear magnetic resonance spectrum apparatus [manufactured by BRUKER, “AVANCE III HD400N type”] at 400 MHz. Deuterated chloroform was used as a solvent.

### Crosslinking Agent

Isocyanate-based crosslinking agent (Fixer #220, trade name, Murayama Chemical Laboratory Co., Ltd.)
Oxazoline-based crosslinking agent (Epocross K-2035E, trade name, Nippon Shokubai Co., LTD.)

### Organic Solvent

1,2-Hexanediol (glycol-based solvent)
SANNIX GP-250 (polyoxyalkylene glyceryl ether, trade name, Sanyo Chemical Industries, Ltd.)

### Viscosity Modifier

SN Thickener 621TF (urethane-based thickener, trade name, SAN NOPCO LIMITED)

### 3.2 Preparation of Printed Matter

Each of the pretreatment liquids for textile printing according to the examples obtained above was applied onto a white cotton T-shirt [manufactured by Printstar, “5.6 ounces CVT heavy weight T-shirt”] as a fabric with a coating amount of 2.0 to 3.0 g/cm² using a paint roller for an aqueous coating. Thereafter, the applied fabric was dried under conditions of a temperature of 185° C., a press load of 0.2 N/cm², and 30 seconds using a flat type sublimation transfer press machine [manufactured by Hasima Co., Ltd., “HSP-5400”], thereby manufacturing a fabric onto which the polyester resin was applied.

A cartridge of an ink jet printer [manufactured by Seiko Epson Corporation, “EW-052A”] was filled with a cyan ink for sublimation transfer [manufactured by Seiko Epson Corporation, “SC23C”]. Thereafter, the image having the filling pattern with a resolution of 96 dpi×96 dpi was printed twice onto a transfer paper for sublimation transfer [manufactured by Seiko Epson Corporation, “DS Transfer General Purpose”], thereby manufacturing a transfer paper onto which the ink was applied.

The image formed at the surface of the transfer paper obtained above was heat-transferred onto the surface of the fabric onto which the polyester resin obtained above was applied using a flat type sublimation transfer press machine [manufactured by Hasima Co., Ltd., “HSP-5400”] under conditions of a temperature of 185° C., a press load of 25 g/cm², and 60 seconds, thereby obtaining each of the printed matter which were the fabrics onto which the cyan ink for sublimation transfer was applied.

### 3.3 Evaluation Method

### 3.3.1 Color Development Property

The recording surface of each of the obtained printed matter was measured with a spectrodensitometer FD-7 (manufactured by Konica Minolta, Inc.) under conditions of a D65 light source and a viewing angle of 2 degrees, thereby measuring the OD value. The color development property was evaluated based on the following evaluation criteria. When the evaluation result is B or more, it can be said that the color development property is excellent.

### Evaluation Criteria

A: The OD of the recording surface is 1.20 or more.
B: The OD of the recording surface is 1.10 or more and less than 1.20.
C: The OD of the recording surface is 1.00 or more and less than 1.10.
D: The OD of the recording surface is less than 1.00.

### 3.3.2 Color Fastness to Change and Fading

The color fastness to change and fading was evaluated by comparing the OD value of the obtained printed matter immediately after printing and the OD value of the printed matter after being left for 3 days. When the evaluation result is B or more, it can be said that the color fastness to change and fading is excellent.

### Evaluation Criteria

A: The rate of change in the OD value was less than 1%.
B: The rate of change in the OD value was 1% or more and less than 2%.
C: The rate of change in the OD value was 2% or more and less than 3%.
D: The rate of change in the OD value was 3% or more.

### 3.3.3. Wash Fastness

For the wash fastness of the obtained printed matter, the laundering fastness test was performed in accordance with A-2 method of JIS L0844 (test method for color fastness to washing). Specifically, the printed matter was washed, rinsed, dehydrated, and dried using a household washing machine (ZABOON (trade name), manufactured by Toshiba Corporation) with a general household laundry detergent (fluorescent whitening agent-free), and then the color fastness to change and fading of the printed matter was determined.

With regard to the color fastness to change and fading, the degree of fading was evaluated according to the following evaluation criteria, according to the gray scale for discoloration of JIS L0804: 2004 (ISO 105-C10 (B2)). When the evaluation result is B or more, it can be said that the wash fastness is excellent.

### Evaluation Criteria

A: The laundering fastness is grade 5 or more.
B: The laundering fastness is grade 4 or more and less than grade 5.
C: The laundering fastness is grade 3 or more and less than grade 4.
D: The laundering fastness is grade 2 or more and less than grade 3.

### 3.3.4 Fabric Hand

The fabric hand property of the obtained printed matter was evaluated by a sensory test. Specifically, the fabric hand property of the obtained printed matter was evaluated by any five evaluators using the following evaluation criteria, in which the evaluation was performed as “the hand feel was not inferior to the original hand feel of the fabric” or “the printed matter was rough and the original hand feel of the fabric was impaired”. When the evaluation result is B or more, it can be said that the fabric hand property is excellent.

### Evaluation Criteria

A: Five evaluators answered that “the hand feel was not inferior to the original hand feel of the fabric”.
B: Four evaluators answered that “the hand feel was not inferior to the original hand feel of the fabric”.
C: Three evaluators answered that “the hand feel was not inferior to the original hand feel of the fabric”.
D: Two or less evaluators answered that “the hand feel was not inferior to the original hand feel of the fabric”.

### 3.4 Evaluation Results

The evaluation results are shown in Table 1.

In each of the examples according to the pretreatment liquid for textile printing, which containing a polyester resin (A) obtained by subjecting an alcohol component and a carboxylic acid component to polycondensation, a crosslinking agent, and water, in which the carboxylic acid component contains phthalic acid, an acid value of the polyester resin (A) is 5 to 40 mgKOH/g, an aromatic ring concentration of the polyester resin (A) is 4.20 to 5.20 mol/kg, and a glass transition temperature of the polyester resin (A) is 0° C. to 40° C., all of color fastness to change and fading, fabric hand, and washing fastness of the textile printed matter were good.

On the other hand, in the pretreatment liquid for textile printing according to each of the comparative examples in which the above-described configuration was not satisfied, at least one of the color fastness to change and fading, the fabric hand, or the washing fastness of the textile printed matter was inferior.

The following contents are derived from the above-described embodiments.

An aspect of a pretreatment liquid for textile printing includes a polyester resin (A) obtained by subjecting an alcohol component and a carboxylic acid component to polycondensation, a crosslinking agent, and water, in which the carboxylic acid component contains phthalic acid, an acid value of the polyester resin (A) is 5 to 40 mgKOH/g, an aromatic ring concentration of the polyester resin (A) is 4.20 to 5.20 mol/kg, and a glass transition temperature of the polyester resin (A) is 0° C. to 40° C.

In one aspect of the pretreatment liquid for textile printing, a peak top molecular weight of the polyester resin (A) may be 3,000 to 20,000.

In any aspect of the pretreatment liquid for textile printing, a hydroxyl value of the polyester resin (A) may be 0 to 40 mgKOH/g.

In any aspect of the pretreatment liquid for textile printing, the carboxylic acid component may further contain isophthalic acid, and a molar ratio (phthalic acid: isophthalic acid) of the phthalic acid to the isophthalic acid may be 1:99 to 99:1.

In any aspect of the pretreatment liquid for textile printing, the pretreatment liquid may contain one or more selected from a glycol-based solvent or a glycerol derivative as an organic solvent.

In any aspect of the pretreatment liquid for textile printing, the pretreatment liquid may contain a viscosity modifier.

In any aspect of the pretreatment liquid for textile printing, a content of the polyester resin (A) may be 1% by mass or more and 20% by mass or less in terms of solid content with respect to a total amount of the pretreatment liquid for textile printing.

An aspect of a textile printing method includes applying the pretreatment liquid for textile printing according to any one of the above-described aspects onto a fabric, drying the fabric to which the pretreatment liquid for textile printing is applied by heating, recording by jetting an ink composition containing a disperse dye and water from an ink jet head to apply the ink composition to an intermediate transfer medium, and transferring the ink composition applied to the intermediate transfer medium onto the fabric to which the pretreatment liquid for textile printing is applied.

The present disclosure is not limited to the above-mentioned embodiment, and various modifications are possible. For example, the present disclosure includes a configuration substantially the same as the configuration described in the embodiment, for example, a configuration having the same function, method, and result, or a configuration having the same object and effect. In addition, the present disclosure includes configurations in which non-essential parts of the configuration described in the embodiments are replaced. In addition, the present disclosure includes configurations that achieve the same operational effects or configurations that can achieve the same objects as those of the configurations described in the embodiments. In addition, the present disclosure includes configurations in which a known technology is added to the configurations described in the embodiments.

What is claimed is:

1. A pretreatment liquid for textile printing, comprising:
a polyester resin (A) obtained by subjecting an alcohol component and a carboxylic acid component to polycondensation;
a crosslinking agent; and
water, wherein
the carboxylic acid component contains phthalic acid,
an acid value of the polyester resin (A) is 5 to 40 mgKOH/g,
an aromatic ring concentration of the polyester resin (A) is 4.20 to 5.20 mol/kg, and
a glass transition temperature of the polyester resin (A) is 0° C. to 40° C.

2. The pretreatment liquid for textile printing according to claim 1, wherein
a peak top molecular weight of the polyester resin (A) is 3,000 to 20,000.

3. The pretreatment liquid for textile printing according to claim 1, wherein
a hydroxyl value of the polyester resin (A) is 0 to 40 mgKOH/g.

4. The pretreatment liquid for textile printing according to claim 1, wherein
the carboxylic acid component further contains isophthalic acid, and
a molar ratio (phthalic acid:isophthalic acid) of the phthalic acid to the isophthalic acid is 1:99 to 99:1.

5. The pretreatment liquid for textile printing according to claim 1, further comprising:
one or more selected from a glycol-based solvent or a glycerol derivative as an organic solvent.

6. The pretreatment liquid for textile printing according to claim 1, further comprising:
a viscosity modifier.

7. The pretreatment liquid for textile printing according to claim 1, wherein
a content of the polyester resin (A) is 1% by mass or more and 20% by mass or less in terms of solid content with respect to a total amount of the pretreatment liquid for textile printing.

8. A textile printing method, comprising:
applying the pretreatment liquid for textile printing according to claim 1 onto a fabric;
drying the fabric to which the pretreatment liquid for textile printing is applied by heating;
recording by jetting an ink composition containing a disperse dye and water from an ink jet head to apply the ink composition to an intermediate transfer medium; and
transferring the ink composition applied to the intermediate transfer medium onto the fabric to which the pretreatment liquid for textile printing is applied.
